(19) United States
(12) Patent Application Publication
(10) Pub. No.: US 2009/0072578 A1
(43) Pub. Date: Mar. 19, 2009

(54) SHADOW SHIELD FOR A VEHICLE

(76) Inventor: Hsin-Fa WANG, Lu Kang Town (TW)

Correspondence Address: EGBERT LAW OFFICES, 412 MAIN STREET, 7TH FLOOR, HOUSTON, TX, 77002, US

(21) Appl. No.: 11/857,143

(22) Filed: Sep. 18, 2007

(51) Int. Cl. B62D 25/00

(52) U.S. Cl. 296/136.12

(57) ABSTRACT

The present invention provides an improved structure of a shadow shield for a vehicle, which is targeted to common vehicles for easy assembly or disassembly. With the help of a rotary rack assembled at the coupling seat of the main frame, the combined vehicle shadow shield can be retracted or unfolded. The swinging end of the rotary rack is provided with a pendulum expansion link, enabling it to drive the shading cloth to fold downwards, and also making the shading cloth fully cover the lateral windows. With the collapsible main frame, the shadow shield can present excellent convenience and efficiency of assembly/disassembly with improved applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a shadow shield, and more particularly to an innovative shadow shield for vehicle applications.

2. Description of Related Art Including Information Disclosed Under 37 CFR 1.97 and 37 CFR 1.98.

Currently, most drivers may be puzzled by the unavailability of satisfactory indoor parking lots or have to park their cars outdoor in some cases.

Faced with the bad weather from global warming, the vehicles parked outdoors will be exposed to high temperatures, no matter whether the driver is on shift at work, on a business tour or otherwise. In such a case, the passengers in the vehicle may be vulnerable to heatstroke due to the sharp temperature difference. In addition, high temperatures may accelerate the degradation and damage of vehicle components, resulting in shorter service life of vehicles.

For this reason, a special sun-shading product is developed for vehicle applications, for example, a shadow shield on the top of training cars or trucks. However, these prior art sun-shading products are normally fixed on top of vehicles, thus affecting their appearance or even safety.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Said shadow shield A may be collapsible or unfolded by incorporating the coupling seat 15 with hack lever 11 and swinging ends 171 of the rotary rack 17. The shading cloth 20 is coupled with main frame 10 and rotary rack 17, thus providing a combined shadow shield A for vehicle applications featuring ease-of-assembly or disassembly. The rotary rack 17 permits the shadow shield A to unfold or to retract rapidly along with the collapsible main frame 10, thus providing excellent convenience and efficiency of assembly/disassembly of shadow shield A.

There is new efficacy of the present invention.

Referring to FIGS. 4, 5, and 6, the swinging end 171 of the rotary rack 17 is provided with a pendulum expansion link 18, which, with the help of pivotal member 19 assembled at one end, may drive the shading cloth 20 to fold downwards, thus making the shading cloth A cover the lateral windows of the vehicle with better shielding effect.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled perspective view of the present invention.

FIG. 2 shows an exploded perspective view of the present invention.

FIG. 3 shows a partially assembled perspective view of the present invention.

FIG. 4 shows a sectional view of the operation of the pendulum expansion link of the present invention.

FIG. 5 shows another sectional view of the operation of the pendulum expansion link of the present invention.

FIG. 6 shows a schematic view of the operation of the present invention.

FIG. 7 shows a lateral schematic view of FIG. 6.

FIG. 8 shows a front schematic view of FIG. 6.

FIG. 9 shows a perspective view of retraction behavior of the present invention.

FIG. 10 shows another schematic view of the operation of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

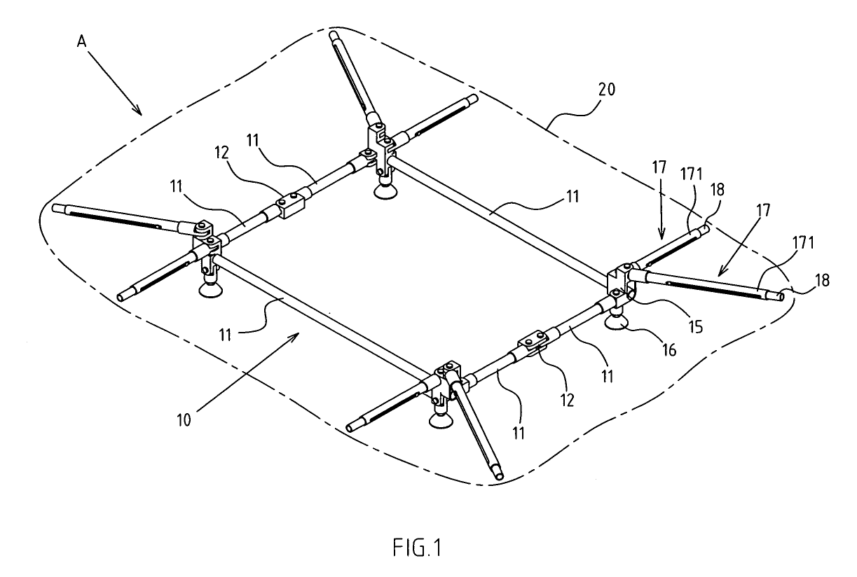

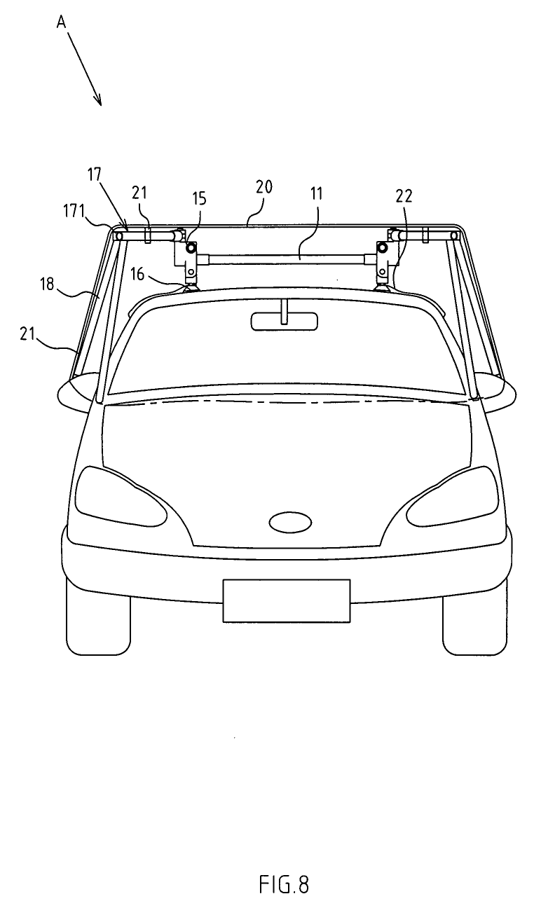

FIGS. 1-9 depict preferred embodiments of an improved vehicle shadow shield of the present invention. The embodiments are provided only for explanatory purposes. The scope of the invention is set by the patent claims.

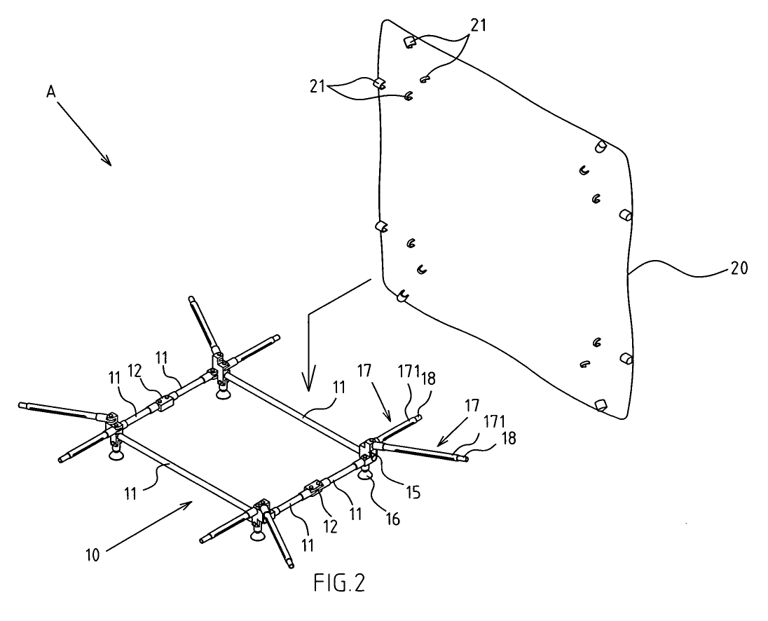

Referring to FIGS. 1 and 2, said shadow shield A comprises a main frame 10 with front, rear, left and right hack levers 11, as well as coupling seats 15 for linking the hack levers 11, thus making the main frame 10 to be expanded into a mouth-shape frame. Assembly member 16 is placed at a bottom of the coupling seat 15. Rotary rack 17 is mounted onto the coupling seat 15, enabling the swinging end 171 of said rotary rack 17 to shift transversely inwards or outwards. A shading cloth 20 is linked to main frame 10 and rotary rack 17. The shading cloth 20 is fitted with through-portion 21 for positioning of rotary rack.

A collapsible member 12 is additionally assembled at a middle section of either hack lever 11 of the main frame 10.

Said assembly member 16 is a sucking disc seat or magnetic seat.

Two sets of rotary racks 17 are assembled onto the coupling seat 15, and the swinging end 171 has different angles of spread.

The swinging end 171 of said rotary rack 17 is provided with pendulum expansion link 18, which drives the shading cloth 20 to bend downwards to preset angle.

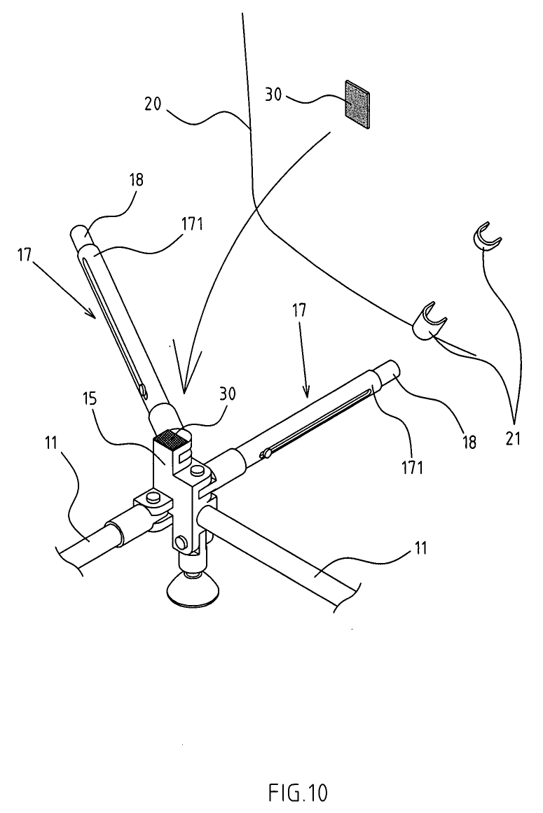

Sliplock fixture 30 is placed between coupling seat 15 and shading cloth 20 of the main frame 10 (shown in FIG. 10).

Based upon above-specified structures, the present invention is operated as follows:

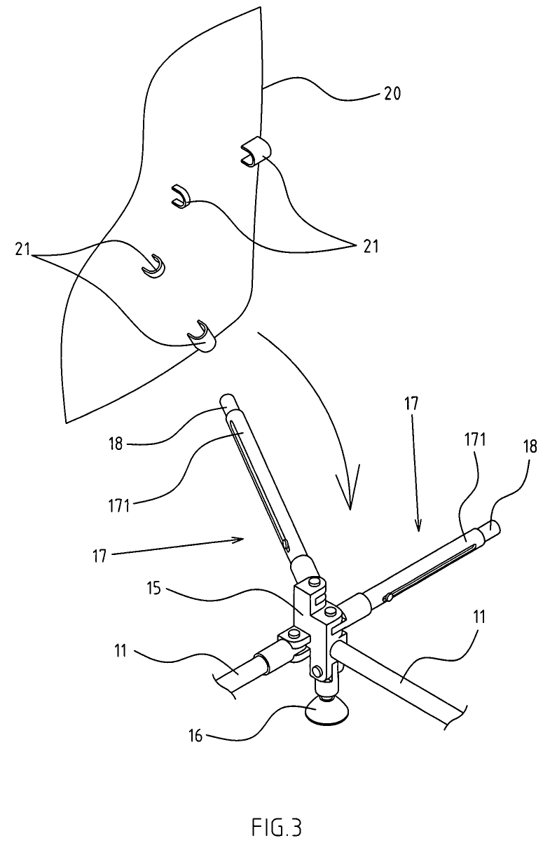

Referring to FIGS. 2 and 3, through-portion 21, at a predefined location of said shading cloth 20, is sleeved into the rotary rack 17 and pendulum expansion link 18 of the coupling seat 15.

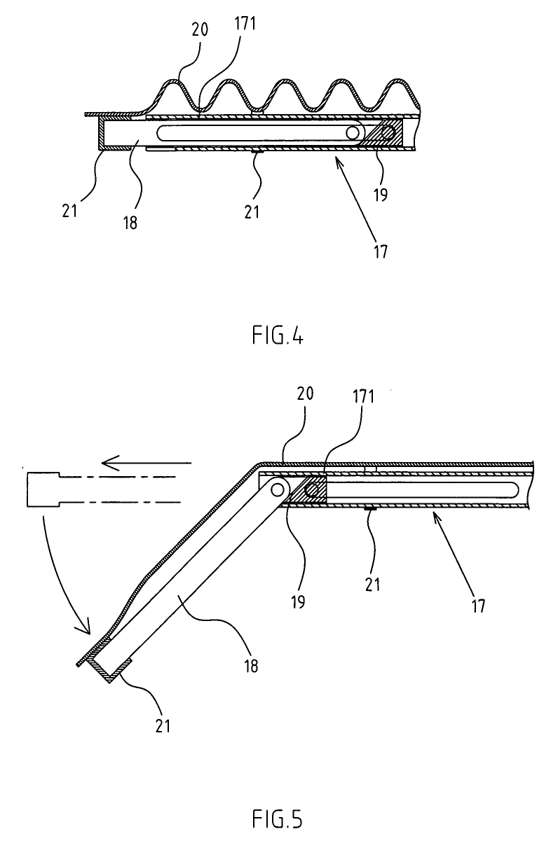

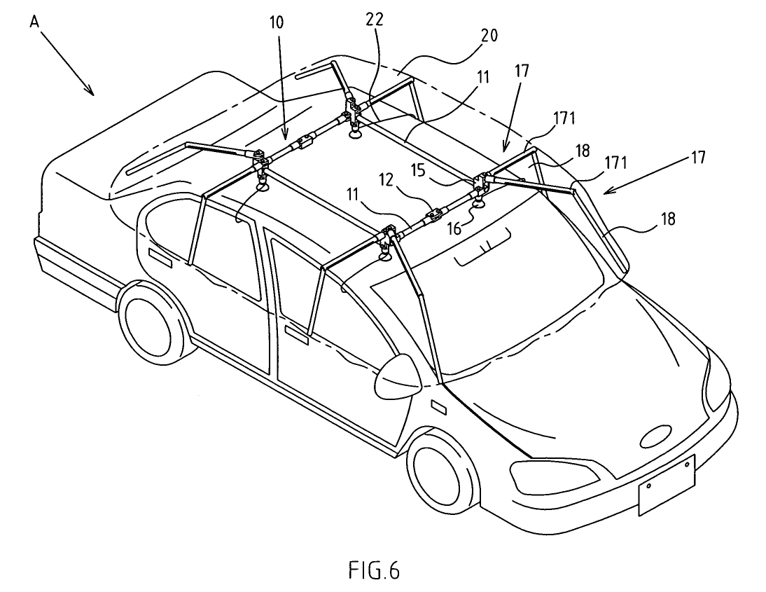

FIGS. 4 and 5 depict schematic drawings of said shading cloth 20 and pendulum expansion link 18 in a collapsible pendulum state. One end of the pendulum expansion link 18 is provided with a pivotal member 19, so that the pendulum expansion link 18 can extend/retract via activation of pivotal member 19. When said pendulum expansion link 18 is extended to predefined angle, the shading cloth 20 of the pendulum expansion link 18 is also expanded to form a downward shielding with present angle.

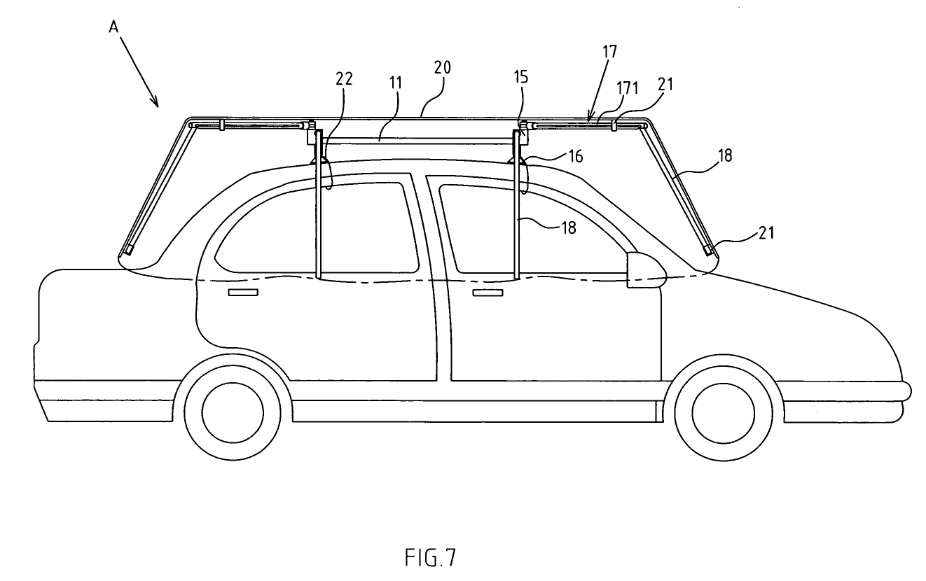

Referring to FIGS. 6, 7 and 8, the fully assembled shadow shield A is mounted via assembly member 16 (e.g. sucking disc seat or magnetic seat) onto the top of vehicle. Hack levers 11 of main frame 10 are expanded so that the swinging end 171 of the rotary rack 17 is rotated outwards to a predefined angle. Next, the pendulum expansion links 18 of swinging ends 171 are extended continuously to a predefined angle. Said shading cloth 20 is expanded to fully cover the top and surrounding windshields of the vehicle, and also penetrate into the vehicle through the gap between lateral windshield and vehicle body via a cord 22 of the assembly member 16. Next, the shield is wrapped onto the assembly member 16 at the other side of the vehicle body, so that the vehicle is protected against sunshine, rainfall, dust or theft.

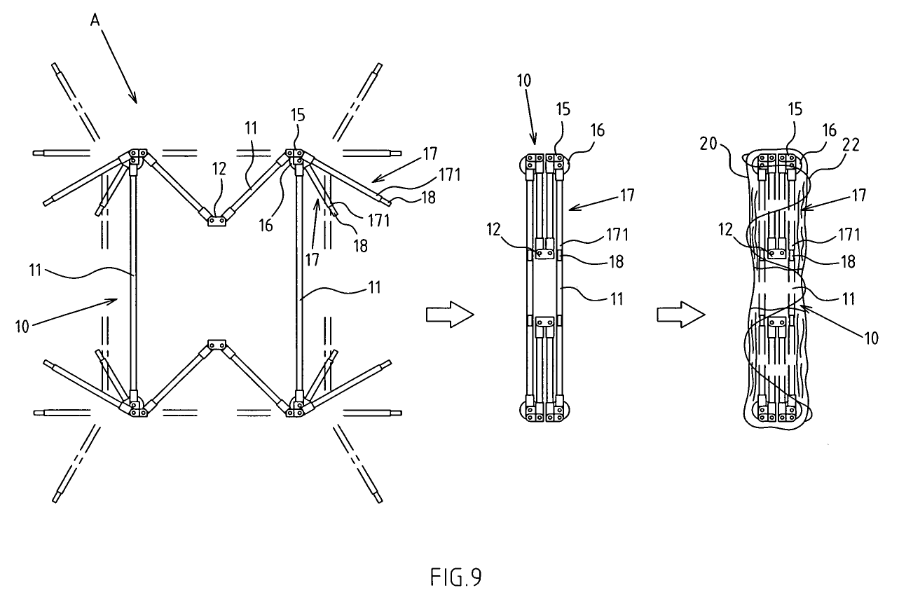

Referring to FIG. 9, when the shadow shield A is collapsed, the pendulum expansion link 18 is retracted to the shortest state. Next, the rotary rack 17 of the coupling seat 15 is collapsed, the same as the hack lever 11 of the collapsible member 12. The shading cloth 20 and main frame 10 are wrapped via the cord 22 of the assembly member 16, so the shadow shield A achieves an optimum retraction and space-saving through simple retraction behavior.

Referring to FIG. 10, said coupling seat 15 and shading cloth 20 can also be fitted with sliplock fixture 30 (e.g. fastener or snappers), enabling optimum assembly state of the shading cloth 20.

1. A shadow shield for vehicle applications, comprising:
a main frame, comprising lateral hack levers and coupling seats linked to said hack levers and forming a mouth-shape frame through said lateral hack levers;
an assembly member, being assembled at a bottom of a coupling seat;
a rotary rack, being assembled at said coupling seat and having a swinging end shifted inwards or outwards when rotary racks are configured into at least two sets, said swinging end being expanded at different angles; and
a shading cloth, being incorporated with said main frame and said rotary rack, said swinging end of said rotary rack being provided with a pendulum expansion link, said shading cloth being driven to fold downwards to a preset angle.

2. The shadow shield defined in claim 1, further comprising:
a collapsible member being assembled at a middle section of either hack lever of said main frame.

3. The shadow shield defined in claim 1, wherein said assembly member is a sucking disc seat or magnetic seat.

4. The shadow shield defined in claim 1, wherein said shading cloth is fitted with a through-portion for positioning rotary racks.

5. The shadow shield defined in claim 1, further comprising:
a sliplock fixture placed between said coupling seat and said shading cloth.
